(19) United States
(12) Patent Application Publication
(10) Pub. No.: US 2013/0292173 A1
(43) Pub. Date: Nov. 7, 2013

(54) CRIMPED TERMINAL WIRE FOR AUTOMOBILE

(71) Applicants: Masato Inoue, Yokkaichi-shi (JP); Takehiro Hosokawa, Yokkaichi-shi (JP); Yasuyuki Otsuka, Yokkaichi-shi (JP); Fumitoshi Imasato, Yokkaichi-shi (JP); Tetsuya Nakamura, Yokkaichi-shi (JP); Shigeyuki Tanaka, Yokkaichi-shi (JP); Yutaka Takata, Yokkaichi-shi (JP); Yoshiaki Yamano, Yokkaichi-shi (JP); Kazunari Sakura, Yokkaichi-shi (JP); Naoya Nishimura, Yokkaichi-shi (JP); Takaaki Ito, Yokkaichi-shi (JP); Akiko Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Daisuke Hashimoto, Yokkaichi-shi (JP); Yukou Sato, Yokkaichi-shi (JP)

(72) Inventors: Masato Inoue, Yokkaichi-shi (JP); Takehiro Hosokawa, Yokkaichi-shi (JP); Yasuyuki Otsuka, Yokkaichi-shi (JP); Fumitoshi Imasato, Yokkaichi-shi (JP); Tetsuya Nakamura, Yokkaichi-shi (JP); Shigeyuki Tanaka, Yokkaichi-shi (JP); Yutaka Takata, Yokkaichi-shi (JP); Yoshiaki Yamano, Yokkaichi-shi (JP); Kazunari Sakura, Yokkaichi-shi (JP); Naoya Nishimura, Yokkaichi-shi (JP); Takaaki Ito, Yokkaichi-shi (JP); Akiko Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Daisuke Hashimoto, Yokkaichi-shi (JP); Yukou Sato, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/978,653

(22) PCT Filed: Feb. 21, 2012
(86) PCT No.: PCT/JP2012/054040

§ 371 Date: Jul. 8, 2013

(30) Foreign Application Priority Data
Feb. 21, 2011 (JP) 2011-034354

(51) Int. Cl. H02G 15/02

(52) U.S. Cl. CPC H02G 15/02
USPC 174/74 R

(57) ABSTRACT

To provide a crimped terminal wire for automobile having a stable anticorrosion property in automobile environment. The wire includes an aluminum electric wire including an aluminum conductor wire coated with insulation, a copper connecting terminal onto an end of the aluminum electric wire, the terminal including a crimped member and an electrical contact portion, a crimped portion, and a resin-coated portion on the crimped portion, wherein an entire periphery of the crimped portion is coated with the resin-coated portion, and wherein the resin-coated portion is made from a material mainly made from a thermoplastic polyamide resin and having a tensile lap-shear strength of lapped aluminums of 6 N/mm² or more in accordance with the JIS K6850, an elongation of 100% or more in accordance with the ASTM D-1708, and a water absorption of 1.0% or less in accordance with the HS K7209.

### TECHNICAL FIELD

The present invention relates to a crimped terminal wire for automobile that includes an aluminum electric wire, and a connecting terminal that is crimped onto an end of the aluminum electric wire.

### BACKGROUND ART

In the field of electric power industry, aluminum electric wires that include conductor wires made from aluminum-based materials that are light in weight and excellent in electrical conductivity are conventionally used as overhead power lines. Meanwhile, in the field of automobile industry, copper electric wires that include conductor wires made from copper-based materials that are excellent in electrical conductivity and in cost efficiency are conventionally used as signal lines and electric power lines.

In these years, electric vehicles and fuel-cell vehicles that can put a reduced burden on the environment have been developed actively in the field of automobile industry. In these kinds of vehicles, electric power lines larger in diameter than conventional signal lines should be used as electric wires connected to batteries and fuel cells because large amounts of electric power need to be transmitted from the batteries and the fuel cells.

Meanwhile, a move to improve fuel efficiency by reducing the weight of automotive vehicles has been accelerated in the field of automobile industry, so that even the total weight of electric wires used in one automotive vehicle cannot be overlooked, and weight reduction of the electric wires is also desired.

Thus, aluminum electric wires that include conductor wires made from aluminum having a specific gravity (2.70 g/cm³) that is about one third of copper (8.96 g/cm³) have been more often used in automobiles in order to reduce the total weight of electric wires.

Conventionally, connecting terminals arranged to connect electric wires with each other, or connect electric wires with terminals of external electronic appliances are used in routing any kinds of electric wires, i.e., not exclusively to routing aluminum electric wires. Most of the connecting terminals are made from copper-based materials from the viewpoints of electrical conductivity and cost efficiency.

The connecting terminals made from copper-based materials are often used also in routing aluminum electric wires in automotive vehicles, so that crimped terminal portions where the connecting terminals are crimped onto the aluminum electric wires define bimetal contact portions. For example, in using connecting terminals made from copper, the difference between the normal electrode potential of copper, which is +0.34 V, and the normal electrode potential of aluminum, which is −1.66 V, becomes 2.00 V, which is large. In addition, in using connecting terminals made from copper that are coated with tin plating, the difference between the normal electrode potential of tin, which is −0.14 V, and the normal electrode potential of aluminum becomes 1.52 V. For this reason, if the crimped terminal portions are exposed to water while the vehicles are moving in the rain or washed, or because of condensation, and an electrolyte solution such as rain water enters to stay in the crimped terminal portions, the three members of aluminum, copper and electrolyte solution, or the three members of aluminum, tin and electrolyte solution form batteries, so that bimetallic corrosion builds up in the aluminum conductors that function as positive electrodes of the batteries.

When ionization of the aluminum electric wires, which are electrically base, proceed to promote the corrosion as described above, the contact states of the crimped terminal portions become worse to cause unstable electrical characteristics of the crimped terminal portions, and there are possibilities that contact resistance could be increased, that electrical resistance could be increased because of the reduced wire diameters, and that the electric wires could be broken. Consequently, the electrical components could malfunction, or could break down.

In order to prevent corrosion from building up in an aluminum electric wire having the configuration described above, PTL 1 discloses a manner for preventing a factor (corrosion factor) such as water and oxygen that causes the corrosion from entering in a bimetal contact portion by coating a portion where an aluminum conductor wire is exposed in a crimped terminal portion with an anticorrosive resin.

### RELATED ART DOCUMENTS

### Patent Documents

PTL 1: Japanese Unexamined Patent Application Publication No. Patent JP 2010-108798

### SUMMARY OF INVENTION

### Problems to be Solved by the Invention

However, while the anticorrosion manner by coating the portion where the aluminum conductor wire is exposed with the anticorrosive agent is easy to use, corrosion could build up in the connecting terminal itself under harsh circumstances. The corrosion that builds up in the connecting terminal causes a problem in that crevice corrosion proceeds between the anticorrosive resin and the connecting terminal to reach the bimetal contact portion where the aluminum electric wire is in contact with the connecting terminal, which significantly promotes corrosion of the aluminum.

Especially in the case of using a generally-used connecting terminal made from a copper-based material that is produced by stamping out a copper plate of which a surface is coated with tin plating and includes a cutting face on which the copper is exposed because no tin plating is applied thereon, corrosion easily builds up in the tin, which is electrically base, at a bimetal contact portion where the copper-exposed portion is in contact with the plated tin because the normal electrode potential of copper is +0.34 V while the normal electrode potential of tin is −0.14 V. When corrosion builds up in the outermost coat of the connecting terminal that is coated with tin plating to reach the resin portion, crevice corrosion proceeds in a crevice between the plated tin and the resin to easily reach the bimetal contact portion between the aluminum electric wire and the connecting terminal.

In this case, if the crevice corrosion that proceeds in the crevice between the connecting terminal and the resin can be inhibited from reaching the bimetal contact portion between the aluminum electric wire and the connecting terminal, corrosion can be prevented from building up in the aluminum electric wire. However, it has not been clear previously how far the crevice corrosion proceeds in the crevice between the connecting terminal and the resin. For this reason, it has not been found in which range a resin-coated portion should be provided in order to inhibit the crevice corrosion from reaching the bimetal contact portion between the aluminum electric wire and the connecting terminal.

The present invention is made in view of the problems described above, and an object of the present invention is, by determining how far crevice corrosion proceeds in a crevice between a connecting terminal made from a copper-based material and a resin (in particular, an organic resin) in an automobile environment, to provide a crimped terminal wire for automobile that includes an aluminum electric wire, a connecting terminal made from a copper-based material that is crimped onto the end of the aluminum electric wire, and a resin-coated portion that is provided in a range capable of inhibiting the crevice corrosion from reaching a bimetal contact portion between the aluminum electric wire and the connecting terminal.

### Means of Solving the Problems

To achieve the objects and in accordance with the purpose of the present invention, a crimped terminal wire for automobile according to the present invention includes an aluminum electric wire including an aluminum conductor wire and an insulation, with which the aluminum conductor wire is coated, a connecting terminal made from a copper-based material and crimped onto an end of the aluminum electric wire, the connecting terminal including a crimped member that is crimped onto the aluminum electric wire and an electrical contact portion, with which the connecting terminal is connected to another terminal, a crimped portion where the connecting terminal is crimped onto the aluminum electric wire, and a resin-coated portion that is made from a resin and provided on the crimped portion, wherein the resin-coated portion is provided on the crimped portion while an entire periphery of the crimped portion is coated with the resin-coated portion, and wherein the resin-coated portion is made from a material that is mainly made from a thermoplastic polyamide resin and has a tensile lap-shear strength of lapped aluminums equal to or more than 6 N/mm² that is measured in accordance with the JIS K6850, an elongation equal to or more than 100% that is measured in accordance with the ASTM D-1708, and a water absorption equal to or less than 1.0% that is measured in accordance with the JIS K7209.

It is preferable that the thermoplastic polyamide resin should be made from at least one of a dimer acid and a dicarboxylic acid, and a diamine.

It is preferable that a portion of the resin-coated portion between a top end of the aluminum conductor wire and a top end of the resin-coated portion should have a length equal to or more than 0.3 mm. It is more preferable that the portion of the resin-coated portion between the top end of the aluminum conductor wire and the top end of the resin-coated portion should have a length equal to or more than 1.0 mm.

Further, it is preferable that a portion of the resin-coated portion, with which a cutting face of the connecting terminal is coated, should have a thickness equal to or more than 0.01 mm. It is more preferable that the portion of the resin-coated portion, with which the cutting face of the connecting terminal is coated, should have a thickness equal to or more than 0.1 mm.

In addition, it is preferable that the resin-coated portion should include a tapered portion at its posterior end portion that has a shape tapering off to the side of the aluminum electric wire. It is preferable that the tapered portion of the resin-coated portion should have a rising angle equal to or less than 45 degrees, and it is more preferable that the tapered portion of the resin-coated portion should have a rising angle equal to or less than 30 degrees. In addition, it is preferable that the tapered portion of the resin-coated portion should have a length equal to or more than 1 mm, and it is more preferable that the tapered portion of the resin-coated portion should have a length equal to or more than 2 mm.

### Effects of the Invention

With the crimped terminal wire for automobile according to the present invention, the entire periphery of the crimped portion of the crimped terminal wire is coated with the resin-coated portion that is made from the resin and provided on the crimped portion where the connecting terminal is crimped onto the aluminum electric wire, so that a corrosion factor can be prevented from easily reaching the bimetal contact portion between the aluminum electric wire and the connecting terminal. Thus, the crimped terminal wire for automobile according to the present invention is capable of preventing corrosion from building up in the aluminum conductor wire, and has a stable anticorrosion property. Further, because the resin-coated portion is made from the material that is mainly made from the thermoplastic polyamide resin and has the physical properties such as the tensile lap-shear strength of lapped aluminums, elongation and water absorption that fall within the respective specific ranges, the crimped terminal wire for automobile according to the present invention is capable of improving anticorrosive capability in terms of material.

If the thermoplastic polyamide resin is made from the at least one of the dimer acid and the dicarboxylic acid, and the diamine, a harmonious balance can be maintained among the physical properties such as tensile lap-shear strength, elongation, water absorption and melt viscosity, so that the material has an excellent coating property during a process of forming the resin-coated portion and excellent anticorrosive capability after the formation of the resin-coated portion that are well balanced.

### BRIEF DESCRIPTION OF THE DRAWINGS

FIG. 1 is a plan view showing one example of a crimped terminal wire according to the present invention;

FIG. 2 is a side view showing the crimped terminal wire shown in FIG. 1;

FIG. 3 is a view showing how crevice corrosion proceeds in a crevice between a connecting terminal and a resin-coated portion shown in FIG. 2;

FIG. 4 is a cross-sectional view of the crimped terminal wire taken along the line A-A of FIG. 1; and

FIG. 5 is a view for schematically illustrating a corrosion test in Examples.

### BEST MODE FOR CARRYING OUT THE INVENTION

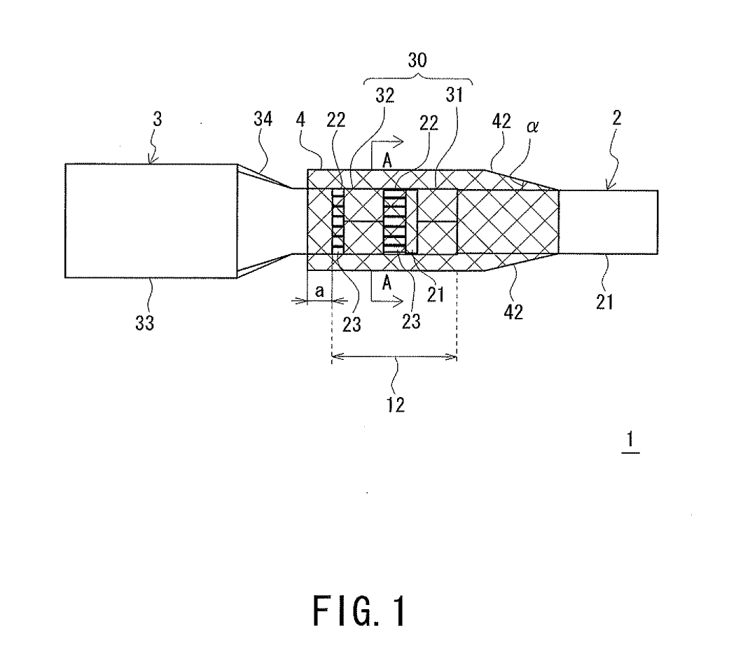

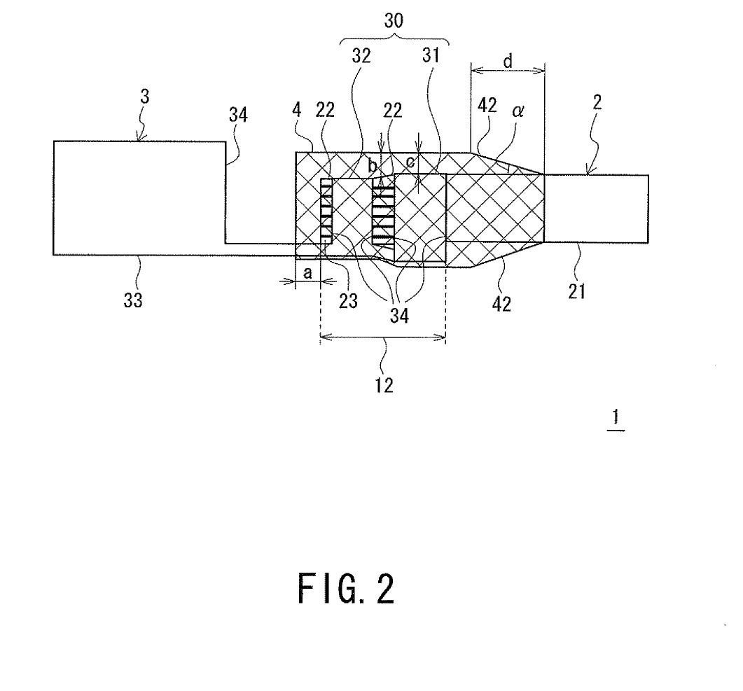

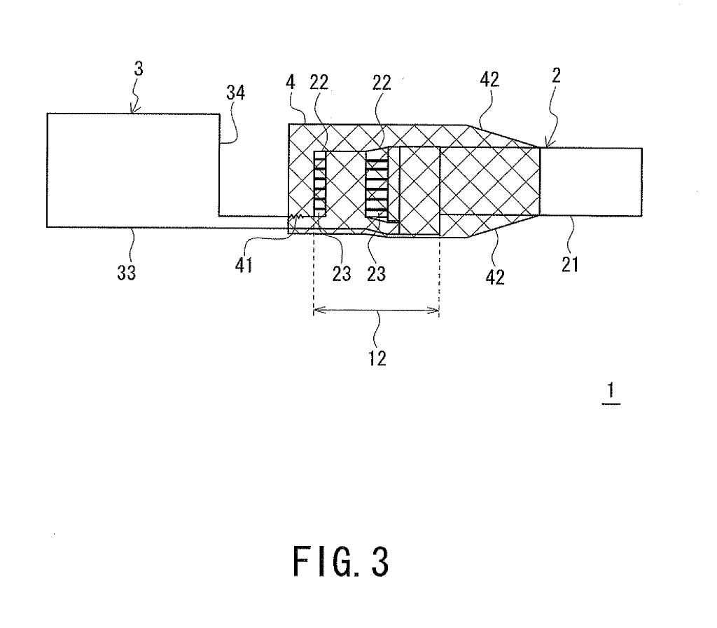

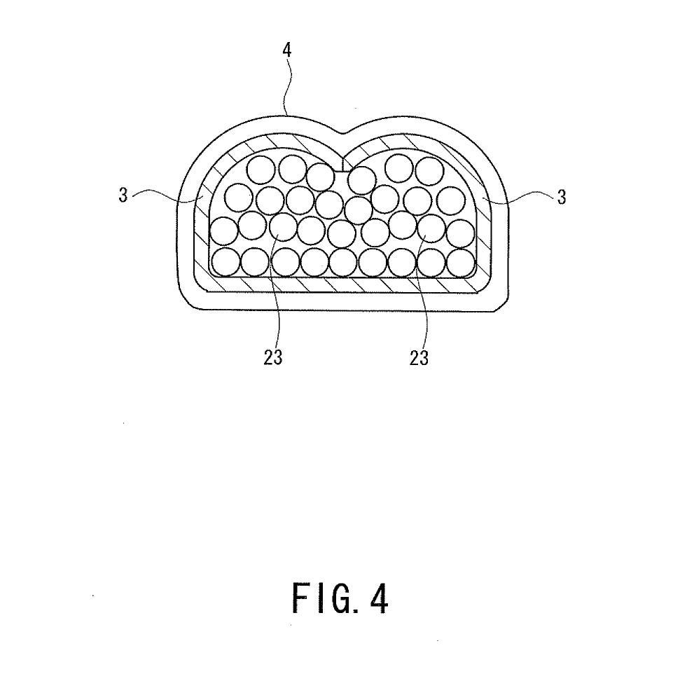

Hereinafter, a detailed description of one embodiment of the present invention will be provided with reference to the accompanying drawings. FIG. 1 is a plan view showing one example of a crimped terminal wire for automobile according to the present invention. FIG. 2 is a side view showing the crimped terminal wire shown in FIG. 1. FIG. 3 is a view showing how crevice corrosion proceeds in a crevice between a connecting terminal and a resin-coated portion shown in FIG. 2. FIG. 4 is a cross-sectional view of the crimped terminal wire taken along the line A-A of FIG. 1. The top of FIG. 2 is referred to as the front face side of the crimped terminal wire, and the bottom of FIG. 2 is referred to as the bottom face side of the crimped terminal wire. The top and bottom of FIG. 1 are referred to as the lateral face sides of the crimped terminal wire.

A crimped terminal wire 1 for automobile (hereinafter, referred to also as the crimped terminal wire 1) according to the present invention includes an aluminum electric wire 2, a connecting terminal 3 made from a copper-based material and crimped onto the end of the aluminum electric wire 2, and a crimped portion 12 where the connecting terminal 3 is crimped onto the aluminum electric wire 2 as shown in FIGS. 1 to 4. The crimped terminal wire 1 further includes a resin-coated portion 4 made from a resin that is provided on the crimped portion 12. While FIGS. 1 to 3 are views showing the external view of the crimped terminal wire 1, the components below the resin-coated portion 4 are shown in FIGS. 1 to 3 through the resin-coated portion 4 that is defined by the diagonally shaded areas in FIGS. 1 to 3, for the sake of illustration.

The aluminum electric wire 2 includes a plurality of aluminum conductor wires 23, and an insulation with which the aluminum conductor wires 23 are coated. The aluminum electric wire 2 consists of an insulation-coated portion 21 where the aluminum conductor wires 23 are coated with the insulation, and a conductor-wire portion 22 where the insulation is peeled away from the end of the aluminum electric wire 2 to expose the aluminum conductor wires 23.

The connecting terminal 3 shown in FIGS. 1 and 2 is made from a copper alloy, a surface of which is coated with tin plating. The connecting terminal 3 is produced by stamping a copper alloy plate that is coated with tin plating so as to have a predetermined shape, and then pressing to bend the stamped plate so as to have a terminal shape. For this reason, a cutting face 34 of the connecting terminal 3 that is produced by stamping the plate is not coated with tin plating. The connecting terminal 3 shown in FIGS. 1 and 2 includes an end face that defines the cutting face 34.

The connecting terminal 3 includes a crimped member 30 that is crimped onto the aluminum electric wire 2, and an electrical contact portion 33 with which the connecting terminal 3 is connected to another terminal. The crimped member 30 includes a wire barrel 32 that is crimped onto the conductor-wire portion 22 of the aluminum electric wire 2, and an insulation barrel 31 that is at a given distance from the wire barrel 32 and crimped onto the insulation-coated portion 21 of the aluminum electric wire 2. The insulation barrel 31 and the wire barrel 32 are connected to each other to be of a monolithic construction on the bottom face of the crimped member 30. The crimped member 30 of the connecting terminal 3 includes clearances provided on its lateral faces and its top face between the insulation barrel 31 and the wire barrel 32 after crimped onto the aluminum electric wire 2. The electrical contact portion 33 defines a female component having a box shape so as to be fitted into a male connecting terminal (not illustrated).

In the crimped terminal wire 1, the insulation barrel 31 is crimped onto the insulation-coated portion 21 of the aluminum electric wire 2 and the wire barrel 32 is crimped onto the conductor-wire portion 22 of the aluminum electric wire 2, whereby the crimped portion 12 is provided as shown in FIGS. 1 and 2. Further, the resin-coated portion 4 made from the resin is provided on the crimped portion 12 while the entire periphery of the crimped portion 12 is coated with the resin-coated portion 4.

In the present invention, “the crimped portion 12” defines a portion corresponding to the crimped member 30 including the insulation barrel 31 and the wire barrel 32 that are crimped onto the aluminum electric wire 2. To be specific, “the crimped portion 12” according to the present invention defines a portion between the front top ends of the aluminum conductor wires 23 and the posterior end of the insulation barrel 31 as shown in FIGS. 1 and 2. In the present invention, the longitudinal direction of the crimped terminal wire 1 is referred to as a back/forth direction, and the side of the crimped terminal wire 1, at which the crimped terminal wire 1 is connected to another terminal, is referred to as the front side for the sake of illustration.

In addition, in the present invention, “the entire periphery” of the crimped portion 12 defines a portion including the periphery in the lateral direction of the crimped portion 12, front top end portions of the aluminum conductor wires 23, the outer surfaces of the insulation barrel 31 and the wire barrel 32, and end faces in the back/forth direction of the insulation barrel 31 and the wire barrel 32 (the cutting faces produced by stamping). To be specific, the resin-coated portion 4 is provided on the crimped portion 12 while an outer peripheral surface of the crimped portion 12, the outer peripheral surface being longer in the back/forth direction than the crimped portion 12, is coated with the resin-coated portion 4.

A portion of the insulation-coated portion 21 and a portion of the aluminum conductor wires 23 are exposed from the clearances between the insulation barrel 31 and the wire barrel 32 on the lateral faces and the top face of the crimped portion 12, so that the portion of the aluminum conductor wires 23 is not covered by the connecting terminal 3. In addition, end portions of the aluminum conductor wires 23 lie off the front end of the wire barrel 32 to the side of the electrical contact portion 33 in the crimped portion 12. The portions of the aluminum conductor wires 23 that are not covered by the connecting terminal 3 are coated with the resin-coated portion 4, so that the aluminum conductor wires 23 are not exposed to the outside.

The configuration that the resin-coated portion 4 made from the resin is provided on the crimped portion 12 while the entire periphery of the crimped portion 12 is coated with the resin coat is capable of preventing rain water from entering the crimped portion 12. The configuration that the outer peripheral surface that is longer in the back/forth direction than the crimped portion 12 is coated with the resin-coated portion 4 while the entire periphery of the crimped portion 12 is coated with the resin-coated portion 4 is capable of inhibiting, for a long period of time, a corrosion factor from entering the crimped portion 12, which is described later. In particular, even if crevice corrosion 41 proceeds in a crevice between the connecting terminal 3 and the resin-coated portion 4 as shown in FIG. 3, this configuration is capable of inhibiting, for a long period of time, the crevice corrosion 41 from reaching a bimetal contact portion where the connecting terminal 3 is in contact with the aluminum conductor wires 23. That is, the crimped terminal wire 1 is capable of preventing, for a long period of time, corrosion from building up in the aluminum conductor wires 23, and thus has a stable anticorrosion property.

Corrosion builds up in the tin at a portion of the connecting terminal 3 that is not coated with the resin-coated portion 4, whereby the tin is eluted. Thus, a bimetal contact portion where the tin is in contact with the copper is exposed. If the bimetal contact portion is exposed to water, the corrosion of the tin, which is electrically base, significantly proceeds, and reaches the resin-coated portion 4. The crevice corrosion 41 could proceed in the crevice between the electrical contact portion 33 of the connecting terminal 3 and the resin-coated portion 4 to reach the bimetal contact portion where the connecting terminal 3 is in contact with the aluminum conductor wires 23. When the crevice corrosion 41 reaches the bimetal contact portion between the connecting terminal 3 and the aluminum conductor wires 23, corrosion significantly proceeds to build up in the aluminum conductor wires 23. In particular, the connecting terminal 3 includes a bimetal contact portion where the cutting face 34 where the copper is exposed from the first is in contact with the tin plated on the surface of the connecting terminal 3, so that corrosion that builds up in the cutting face 34 exerts a large influence.

It is preferable that a portion a of the resin-coated portion 4 between the top ends of the aluminum conductor wires 23 and the top end of the resin-coated portion 4 should have a length equal to or more than 0.3 mm, and it is more preferable that the portion a should have a length equal to or more than 1.0 mm as shown in FIGS. 1 and 2. This configuration allows the portion between the top ends of the aluminum conductor wires 23 and the top end of the resin-coated portion 4 to have a length enough to prevent the crevice corrosion 41 that proceeds in the crevice between the resin-coated portion 4 and the connecting terminal 3 from easily reaching the bimetal contact portion between the aluminum conductor wires 23 and the connecting terminal 3.

In addition, it is preferable that a portion of the resin-coated portion 4 with which the aluminum conductor wires 23 are coated (the portion indicated with a reference character b in FIG. 2) should have a thickness equal to or more than 0.01 mm. This configuration is capable of preventing a corrosion factor from getting into the resin-coated portion 4 to be in contact with the aluminum conductor wires 23 even when a fine defect such as a flaw is produced on the surface of the resin-coated portion 4. Further, it is more preferable that the portion of the resin-coated portion 4 with which the aluminum conductor wires 23 are coated should have a thickness equal to or more than 0.1 mm. This configuration is capable of preventing a corrosion factor from getting into the resin-coated portion 4 even when a larger flaw is produced on the surface of the resin-coated portion 4. Thus, having this configuration, the crimped terminal wire 1 for automobile is capable of more effectively preventing corrosion.

In addition, it is preferable that a portion of the resin-coated portion 4 with which the cutting face of the connecting terminal 3 is coated (the portion indicated with a reference character c in FIG. 2) should have a thickness equal to or more than 0.01 mm. This configuration is capable of preventing a corrosion factor from getting into the resin-coated portion 4 to be in contact with the cutting face of the connecting terminal 3 even when a fine defect such as a flaw is produced on the surface of the resin-coated portion 4. Further, it is more preferable that the portion of the resin-coated portion 4 with which the cutting face of the connecting terminal 3 is coated should have a thickness equal to or more than 0.1 mm. This configuration is capable of preventing a corrosion factor from getting into the resin-coated portion 4 even when a larger flaw is produced on the surface of the resin-coated portion 4. Thus, having this configuration, the crimped terminal wire 1 for automobile is capable of more effectively preventing corrosion.

Further, the resin-coated portion 4 includes a tapered portion 42 at its posterior end portion, the tapered portion 42 having the shape tapering off to the side of the aluminum electric wire 2. The tapered portion 42 is provided on the insulation-coated portion 21. The inclusion of the tapered portion 42 prevents the resin coat of the resin-coated portion 4 from being easily peeled away from the aluminum electric wire 2 when the crimped terminal wire 1 is bent. Consequently, this configuration is capable of preventing a corrosion factor from getting into a crevice between the resin-coated portion 4 and the aluminum electric wire 2, whereby the aluminum conductor wires 23 have their anticorrosion properties maintained. In this case, it is preferable that the tapered portion 42 should have a rising angle α equal to or less than 45. This configuration is capable of more effectively preventing the resin coat of the resin-coated portion 4 from being peeled away from the aluminum electric wire 2. Further, it is more preferable that the tapered portion 42 should have a rising angle α equal to or less than 30 degrees. This configuration is capable of preventing the resin coat of the resin-coated portion 4 from being peeled away from the aluminum electric wire 2 even when the crimped terminal wire 1 is bent at a larger bending angle, or bent repeatedly a plurality of times.

It is preferable that the tapered portion 42 of the resin-coated portion 4 should have a length d equal to or more than 1 mm. Even when the resin coat of the resin-coated portion 4 is peeled away slightly from the aluminum electric wire 2, this configuration is capable of preventing the peel from easily reaching the crimped portion 12, and is thus capable of effectively preventing a corrosion factor from getting into the crimped portion 12. That is, the crimped terminal wire 1 having this configuration has a stable anticorrosion property. It is more preferable that the tapered portion 42 of the resin-coated portion 4 should have a length d equal to or more than 2 mm. This configuration is capable of more effectively preventing a corrosion factor from getting into the crimped portion 12.

Examples of a method for producing the resin-coated portion 4 include a molding method by injecting a resin in an appropriate die in which a crimped terminal wire is placed, and a molding method by dropping a molten resin on an appropriate site.

In producing the resin-coated portion 4, the length of the portion between the top ends of the aluminum conductor wires 23 and the top end of the resin-coated portion 4, the thickness of the resin coat, and the length and the angle of the tapered portion 42 of the resin coat can be adjusted by using a molding method by injecting a resin in an appropriate die, or a method by dropping a generous amount of molten resin and then scraping excess off after the resin is solidified.

The resin-coated portion 4 is made from a material that is mainly made from a thermoplastic polyamide resin. It is preferable that the thermoplastic polyamide resin should be made from at least one of a dimer acid and a dicarboxylic acid, and a diamine. This is because a harmonious balance can be maintained among physical properties such as tensile lap-shear strength, elongation, water absorption and melt viscosity, so that the thermoplastic polyamide resin has an excellent coating property and excellent anticorrosive capability that are well balanced.

It is preferable that the resin-coated portion 4 should be made from a single kind of a thermoplastic polyamide resin, or it is also preferable that the resin-coated portion 4 should be made from two or more different kinds of thermoplastic polyamide resins. Further, it is also preferable that the resin-coated portion 4 should further contain an additive and another polymer as appropriate within a range of not impairing its physical properties.

The additive described above is not limited specifically as long as the additive defines an additive that can be generally used for a material for resin molding. To be specific, examples of the additive include an inorganic filler, an antioxidant, a metal deactivator (a copper inhibitor), an ultraviolet absorber, an ultraviolet-concealing agent, a flame-retardant auxiliary agent, a processing aid (e.g., a lubricant, wax), and carbon and other coloring pigments.

It is preferable that the resin-coated portion 4 should be cross-linked as appropriate in order to increase heat resistance and mechanical strength. Examples of a method for the crosslinking include a thermal crosslinking method, a chemical crosslinking method, a silane crosslinking method, an electron irradiation crosslinking method, and an ultraviolet crosslinking method, and the method is not limited specifically. The resin-coated portion 4 is preferably cross-linked after the resin-coated portion 4 is formed.

The material from which the resin-coated portion 4 is made has a tensile lap-shear strength of lapped aluminums equal to or more than 6 N/mm² that is measured in accordance with the JIS K6850. It is to be noted that the JIS K6850 (“Adhesives-Determination of tensile lap-shear strength of rigid-to-rigid bonded assemblies”) stipulates determination of tensile lap-shear strength of rigid-to-rigid bonded assemblies by using a standard test specimen under specified adjustment and test conditions. In the present invention, aluminum boards are used as the rigid-to-rigid bonded assemblies and the material described above is used as a bonding layer sandwiched by the aluminum boards, and thus a test specimen is prepared.

If the tensile lap-shear strength of lapped aluminums is less than 6 N/mm², it is difficult to bring the material from which the resin-coated portion 4 is made, even melted, into intimate contact with a portion where corrosion prevention is needed. Therefore, it is difficult for the material from which the resin-coated portion 4 is made to obtain a high anticorrosion effect. It is preferable that the material from which the resin-coated portion 4 is made should have a tensile lap-shear strength of lapped aluminums equal to or more than 7 N/mm², and it is more preferable that the material from which the resin-coated portion 4 is made should have a tensile lap-shear strength of lapped aluminums equal to or more than 8 N/mm². The upper limit of the tensile lap-shear strength of lapped aluminums is not limited specifically because the material from which the resin-coated portion 4 is made is desired to have sufficient adhesion.

In addition, the material from which the resin-coated portion 4 is made has an elongation (at normal temperature of 24 degrees C.) equal to or more than 100% that is measured in accordance with the ASTM D-1708.

If the elongation is less than 100%, a shrinkage crack is produced in the material from which the resin-coated portion 4 is made when the material is cooled and hardened after melted and applied on the portion where corrosion prevention is needed. Due to this, water is immersed into the crack, so that it is difficult for the material from which the resin-coated portion 4 is made to obtain a high anticorrosion effect. It is preferable that the material from which the resin-coated portion 4 is made should have an elongation equal to or more than 150%, and it is more preferable that the material from which the resin-coated portion 4 is made should have an elongation equal to or more than 200%. The upper limit of the elongation is not limited specifically because the material from which the resin-coated portion 4 is made is desired to have a sufficient elongation.

In addition, the material from which the resin-coated portion 4 is made has a water absorption equal to or less than 1.0% that is measured in accordance with the JIS K7209. The water absorption defines a value that is measured in an A-method under the conditions that an immersion period is 7 days, and the shape of test specimen is a sheet shape.

If the water absorption is more than 1.0%, the material from which the resin-coated portion 4 is made is liable to absorb water depending on its use environment such as automobile environment. Therefore, it is difficult for the material from which the resin-coated portion 4 is made to obtain a high anticorrosion effect. It is preferable that the material from which the resin-coated portion 4 is made should have a water absorption equal to or less than 0.8%, and it is more preferable that the material from which the resin-coated portion 4 is made should have a water absorption equal to or less than 0.5%. The lower limit of the water absorption is not limited specifically because the material from which the resin-coated portion 4 is made is desired to have a water absorption as low as possible.

Because the material from which the resin-coated portion 4 is made is mainly made from the thermoplastic polyamide resin and has the physical properties such as tensile lap-shear strength of lapped aluminums, elongation and water absorption that fall within the respective specific ranges, the crimped terminal wire 1 for automobile according to the present invention is capable of improving anticorrosive capability in terms of material.

If the thermoplastic polyamide resin is made from the at least one of the dimer acid and the dicarboxylic acid, and the diamine, a harmonious balance can be maintained among the physical properties such as tensile lap-shear strength, elongation, water absorption and melt viscosity, so that the material has an excellent coating property during a process of forming the resin-coated portion 4 and excellent anticorrosive capability after the formation of the resin-coated portion 4 that are well balanced.

### EXAMPLE

Hereinafter, Examples of the present invention, and Comparative Examples are presented.

### Example 1

### Samples 1 to 16

Crimped terminal wires 1 of samples 1 to 16 consistent with Example 1 were prepared as follows: the crimped terminal wires 1 were prepared, each of which included a connecting terminal 3 that defined a 090 female connecting terminal, an aluminum electric wire 2 that defined an aluminum electric wire 0.75 mm² or 2.5 mm² in diameter, and a resin-coated portion 4 that was made from a polyimide resin (manuf.: HENKEL JAPAN LTD., trade name: “MACROMELT 6202”) such that the lengths a of the portions between the top ends of the aluminum conductor wires 23 and the top ends of the resin-coated portions 4, the thicknesses b of the portions of the resin-coated portions 4 with which the upper sides of the conductor-wire portions 22 were coated, and the thicknesses c of the portions of the resin-coated portions 4 with which the cutting faces of the connecting terminals 3 were coated, which were shown in FIG. 1, were varied among the crimped terminal wires 1. Corrosion tests (JIS C 0023) were carried out on the crimped terminal wires 1 of samples 1 to 16. The test time of each corrosion test was set to be twenty-four hours. After picking up the crimped terminal wires 1 of samples 1 to 16 from a neutral salt spray apparatus, the crimped terminal wires 1 of samples 1 to 16 were checked for corrosion by visual external observation. This process was counted as one cycle, and repeated again if no corrosion built up in the crimped terminal wires 1 of samples 1 to 16. Results of the corrosion tests are presented in Table 1 as the numbers of cycles when corrosion built up.

### Comparative Examples 1 and 2

Crimped terminal wires 1 consistent with Comparative Examples 1 and 2 were prepared as follows in a similar manner to the crimped terminal wires 1 consistent with Example 1 described above except that the cutting faces of the connecting terminals 3 were not coated with a resin while the resin-coated portions 4 were provided only on the conductor-wire portions 22 of the crimped portions 12. Corrosion tests were carried out on the crimped terminal wires 1 consistent with Comparative Examples 1 and 2. Results of the corrosion tests carried out on the crimped terminal wires 1 consistent with Comparative Examples 1 and 2 are presented in Table 1.

TABLE 1

| | | Length between | | Thickness of resin- | |
|---|---|---|---|---|---|
| | | aluminum conductor | Thickness of resin- | coated portion | |
| | | wire top end to | coated portion | coating cutting face | |
| | Wire | resin-coated portion | coating aluminum | of connecting | Cycle number |
| | diameter | top end | conductor wires | terminal | when corrosion |
| Sample No. | (mm²) | a (mm) | b (mm) | c (mm) | built up |
| 1 | 0.75 | 1.0 | 0.1 | 0.1 | 11 |
| 2 | 0.75 | 0.3 | 0.1 | 0.1 | 4 |
| 3 | 0.75 | 0.2 | 0.1 | 0.1 | 2 |
| 4 | 0.75 | 1.0 | 0.01 | 0.1 | 6 |
| 5 | 0.75 | 1.0 | 0.005 | 0.1 | 2 |
| 6 | 0.75 | 1.0 | 0.1 | 0.01 | 6 |
| 7 | 0.75 | 1.0 | 0.1 | 0.005 | 3 |
| 8 | 0.75 | 1.3 | 2.4 | 1.7 | 15 |
| 9 | 2.5 | 1.0 | 0.1 | 0.1 | 10 |
| 10 | 2.5 | 0.3 | 0.1 | 0.1 | 4 |
| 11 | 2.5 | 0.2 | 0.1 | 0.1 | 2 |
| 12 | 2.5 | 1.0 | 0.01 | 0.1 | 5 |
| 13 | 2.5 | 1.0 | 0.005 | 0.1 | 2 |
| 14 | 2.5 | 1.0 | 0.1 | 0.01 | 6 |
| 15 | 2.5 | 1.0 | 0.1 | 0.005 | 3 |
| 16 | 2.5 | 1.3 | 1.03 | 0.4 | 14 |
| Comparative | 0.75 | 0.3 | 1.00 | 0 | 1 |
| Example 1 | | | | | |
| Comparative | 2.5 | 0.3 | 1.00 | 0 | 1 |
| Example 2 | | | | | |

As is evident from Table 1, the crimped terminal wires 1 of samples 1 to 16 consistent with Example 1 that have the configurations that the entire peripheries of the crimped portions 12 are coated with the resin-coated portions 4 are capable of resisting the corrosion environment for a long period of time compared with the crimped terminal wires 1 consistent with Comparative Examples 1 and 2 that have configurations that the entire peripheries of the crimped portions 12 are not coated with the resin-coated portions 4. In addition, the crimped terminal wires 1 of samples 1 to 16 consistent with Example 1 that have the configurations that the lengths of the portions between the top ends of the aluminum conductor wires 23 and the top ends of the resin-coated portions 4 are larger are capable of preventing the crevice corrosions 41 from easily reaching the bimetal contact portions between the aluminum conductor wires 23 and the connecting terminals 3. Thus, the crimped terminal wires 1 of samples 1 to 16 consistent with Example 1 are capable of resisting the corrosion environment for a long period of time.

### Example 2

### Samples 17 to 30

Next, crimped terminal wires 1 of samples 17 to 30 consistent with Example 2 were prepared. The crimped terminal wires 1 of samples 17 to 28 were provided with the resin-coated portions 4 including tapered portions 42 at their posterior end portions. The crimped terminal wires 1 of samples 29 and 30 were provided with the resin-coated portions 4 including no tapered portion 42. Bending tests were carried out on the crimped terminal wires 1 of samples 17 to 30. After the tests, the crimped terminal wires 1 of samples 17 to 30 were checked as to the degrees of peeling of the resin coats of the resin-coated portions 4 from the aluminum electric wires 2. The lengths of the tapered portions 42 were expressed as d, and the rising angles of the tapered portions 42 were expressed as cc. The crimped terminal wires 1 were bent while held at the portions that were three centimeters behind the posterior ends of the insulation barrels 31 and the electrical contact portions 33 of the connecting terminals 3, where bending ninety degrees in the crimping face direction and then ninety degrees in the opposite direction was counted as one bending time. The numbers of bending times when peeling of the resin coats of the resin-coated portions 4 that reached the insulation barrels 31 were produced were counted. The crimped terminal wires 1 of samples 17 to 30 were checked for peeling of the resin coats by visual observation. In Example 2, the lengths a of the portions between the top ends of the aluminum conductor wires 23 and the top ends of the resin-coated portions 4 were 1 mm, the thicknesses b of the portions of the resin-coated portions 4, with which the upper sides of the conductor-wire portions 22 were coated, were 0.1 mm, and the thicknesses c of the portions of the resin-coated portions 4, with which the cutting faces of the connecting terminals 3 were coated, were 0.1 mm.

TABLE 2

| | | Tapered | Tapered | Bending-time |
|---|---|---|---|---|
| | Wire | portion | portion | number when |
| | diameter | angle | length | peeling reached |
| Sample No. | (mm²) | α(°) | d(mm) | insulation barrel |
| 17 | 0.75 | 30 | 2 | 15 |
| 18 | 0.75 | 30 | 1 | 12 |
| 19 | 0.75 | 30 | 0.8 | 10 |
| 20 | 0.75 | 45 | 2 | 12 |
| 21 | 0.75 | 60 | 2 | 10 |
| 22 | 0.75 | 40 | 2 | 13 |
| 23 | 2.5 | 30 | 2 | 9 |
| 24 | 2.5 | 30 | 1 | 6 |
| 25 | 2.5 | 30 | 0.8 | 4 |
| 26 | 2.5 | 45 | 2 | 5 |
| 27 | 2.5 | 60 | 2 | 3 |
| 28 | 2.5 | 11 | 2 | 13 |
| 29 | 0.75 | 90 | 1.00* | 1 |
| 30 | 2.5 | 90 | 1.00* | 1 |

*The length of the tapered portion between the posterior end of the insulation barrel and the posterior end of the resin-coated portion

As is evident from Table 2, the configurations that the resin-coated portions 4 include the tapered portions 42 at their posterior end portions are capable of preventing crevices from easily being formed between the resin-coated portions 4 and the aluminum electric wires 2 even when the crimped terminal wires 1 consistent with Example 2 are bent. That is, these configurations are capable of preventing a corrosion factor from easily reaching the insulation barrels 31 to prevent corrosion from building up from the posterior end portions of the resin-coated portions 4. It is shown that as the lengths of the tapered portions 42 are larger, the resin coats of the resin-coated portions 4 are less easily peeled away from the aluminum electric wires 2. It is also shown that as the rising angles α of the tapered portions are smaller, the resin-coated portions 4 are less easily peeled away from the insulation-coated portions 21 of the aluminum electric wires 2.

### Example 3

Next, evaluations of anticorrosive capability were performed in terms of material.

1. Preparation of Aluminum Electric Wires

A polyvinyl chloride composition was prepared as follows: 100 parts by mass of polyvinyl chloride (polymerization degree of 1300) was mixed with 40 parts by mass of diisononyl phthalate that defines a plasticizer, 20 parts by mass of calcium carbonate heavy that defines a filler, and 5 parts by mass of a calcium-zinc stabilizer that defines a stabilizer at 180 degrees C. in an open roll, and the mixture was formed into pellets with the use of pelletizer.

Then, a conductor (having a cross-sectional area of 0.75 mm) that defines an aluminum alloy strand that is made up of seven aluminum alloy wires was extrusion-coated with the polyvinyl chloride composition prepared as above such that the coat has a thickness of 0.28 mm. Thus, an aluminum electric wire (PVC electric wire) was prepared.

2. Crimping of Terminal Members and Formation of Resin-Coated Portions

By using a plurality of the aluminum electric wires prepared as above, aluminum electric wires with terminals were prepared as follows. The coat was peeled off at an end of each aluminum electric wire to expose the wire conductor group, and then a male terminal member (0.64 mm in width at a tub, and including a crimped portion arranged to be crimped onto the conductor group, and a crimped portion arranged to be crimped onto the insulation-coated portion) made of brass that is generally used for automobile was crimped onto the end of each aluminum electric wire.

Then, materials of different kinds to be described later were each applied to crimped portions where the terminal members were crimped onto the aluminum electric wires while entire peripheries of the crimped portions were coated with the materials. Thus, the resin-coated portions were formed. It is to be noted that the materials were heated to 230 degrees C. to fluidify and applied such that each coat had a thickness of 0.05 mm, and the coats were solidified.

### Sample 31

Thermoplastic polyamide resin (A) [manuf.: HENKEL JAPAN LTD., “MACROMELT (a registered trade mark) 6801”]

### Sample 32

Thermoplastic polyamide resin (B) [manuf.: HENKEL JAPAN LTD., “MACROMELT (a registered trade mark) JP116”]

### Sample 33

Thermoplastic polyamide resin (C) [manuf.: HENKEL JAPAN LTD., “MACROMELT (a registered trade mark) 6301”]

### Comparative Example 3

Thermoplastic polyamide resin (a) [manuf.: HENKEL JAPAN LTD., “MACROMELT (a registered trade mark) 6217”]

### Comparative Example 4

Thermoplastic polyamide resin (b) [manuf.: HENKEL JAPAN LTD., “MACROMELT (a registered trade mark) 6030”]

### Comparative Example 5

Thermoplastic polyamide resin (c) [manuf.: HENKEL JAPAN LTD., “MACROMELT (a registered trade mark) 6880”]

3. Evaluation Procedure

Evaluations of anticorrosive capability were performed on the crimped terminal wires on which the resin-coated portions made from the materials of different kinds were formed by detecting the presence or absence of a crack formed in the resin-coated portions.

(Crack)

After coated with the materials of different kinds, the aluminum electric wires with the terminals were left in the air for one day, and the detection of the presence or absence of a crack formed in the materials was performed with eyes by using a microscope. The aluminum electric wires with the terminals in which cracks were absent in the materials were rated GOOD. The aluminum electric wires with the terminals in which cracks were present in the materials were rated POOR.

(Anticorrosive Capability)

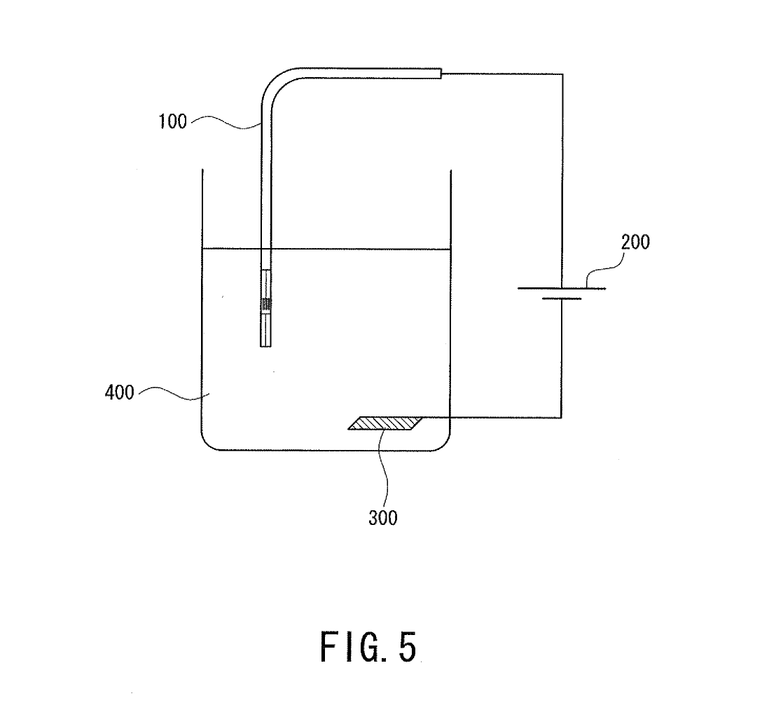

As shown in FIG. 5, each of the prepared aluminum electric wires 100 with the terminals was connected to a positive electrode of an electrical power source 200 of 12 volts, while a pure copperplate 300 (1 cm in width×2 cm in length×1 mm in thickness) was connected to a negative electrode of the electrical power source 200 of 12 volts. The pure copper plate 300 and each of the crimped members 30 between the conductor groups of the aluminum electric wires 100 and the terminal members were immersed in 300 cc of a water solution 400 containing 5% of NaCl, and a voltage of 12 volts was applied to the pure copper plate 300 and each of the crimped members 30 for two minutes. After the application of the voltage, ICP emission analysis of the water solution 400 containing 5% of NaCl was performed to measure the amounts of aluminum ions eluted from each of the conductor groups of the aluminum electric wires 100 with the terminals. The aluminum electric wires 100 with the terminals in which the amounts of aluminum ions eluted from the conductor groups were less than 0.1 ppm were rated GOOD. The aluminum electric wires 100 with the terminals in which the amounts of aluminum ions eluted from the conductor groups were equal to or more than 0.1 ppm were rated POOR.

Tensile lap-shear strengths of lapped aluminums of the materials that were measured in accordance with the JIS K6850, elongations (at normal temperature of 24 degrees C.) of the materials that were measured in accordance with the ASTM D-1708, and water absorptions that were measured in accordance with the JIS K7209 (A-method under the conditions that an immersion period is 7 days, the shape of test specimens is a sheet shape), and evaluation results of the materials are presented in Table 3.

TABLE 3

| | | | | | Comparative | Comparative | Comparative |
|---|---|---|---|---|---|---|---|
| | | No. 31 | No. 32 | No. 33 | Example 3 | Example 4 | Example 5 |
| Tensile lap-shear strength (Al/Al) | (N/mm2) | 10.8 | 10.8 | 6.7 | 2.1 | 4.4 | 3.4 |
| Elongation | (%) | 1000 | 780 | 840 | 120 | 20 | 96 |
| Water absorption (7 days) | (%) | 0.78 | 0.89 | 0.43 | 1.5 | 0.23 | 2.34 |
| Crack | | GOOD | GOOD | GOOD | GOOD | POOR | POOR |
| Anticorrosive capability | | GOOD | GOOD | GOOD | POOR | POOR | POOR |

As is evident from Table 3, because the resin-coated portion consistent with Comparative Example 3 is made from the material having a tensile lap-shear strength and a water absorption that fall outside the ranges defined by the present invention, the resin-coated portion consistent with Comparative Example 3 is insufficient in adhesion, liable to absorb water, and inferior in anticorrosive capability.

The resin-coated portion consistent with Comparative Example 4 is made from the material having a tensile lap-shear strength and an elongation that fall outside the ranges defined by the present invention, so that the resin-coated portion consistent with Comparative Example 4 is insufficient in adhesion, and inferior in anticorrosive capability because water is immersed into a formed crack.

The resin-coated portion consistent with Comparative Example 5 is made from the material having a tensile lap-shear strength, an elongation and a water absorption that all fall outside the ranges defined by the present invention, so that the resin-coated portion consistent with Comparative Example 5 is insufficient in adhesion, liable to absorb water, and inferior in anticorrosive capability because water is immersed into a formed crack.

Meanwhile, the resin-coated portions consistent with present Examples (Samples 31 to 33) are made from the materials having a tensile lap-shear strength, an elongation and a water absorption that fall within the ranges defined by the present invention, so that the resin-coated portions consistent with present Examples (Samples 31 to 33) have sufficient adhesion to the electrically connected portions, and can prevent water immersion. In addition, the resin-coated portions consistent with present Examples (Samples 31 to 33) are made from the materials that are excellent in coating property compared with grease. In addition, a shrinkage crack due to cooling is seldom produced in the resin-coated portions consistent with present Examples (Samples 31 to 33) after application. Thus, the materials according to the present invention are capable of improving anticorrosive capability in terms of material.

The foregoing description of the embodiments of the present invention has been presented for purposes of illustration and description; however, it is not intended to be exhaustive or to limit the present invention to the precise form disclosed, and modifications and variations are possible as long as they do not deviate from the principles of the present invention.

1-13. (canceled)

14. A crimped terminal wire for automobile, the wire comprising:
an aluminum electric wire comprising:
an aluminum conductor wire; and
an insulation, with which the aluminum conductor wire is coated;
a connecting terminal comprising a copper-based material and crimped onto an end of the aluminum electric wire, the connecting terminal comprising:
a crimped member that is crimped onto the aluminum electric wire; and
an electrical contact portion, with which the connecting terminal is connected to another terminal;
a crimped portion where the connecting terminal is crimped onto the aluminum electric wire; and
a resin-coated portion that comprises a resin, and is provided on the crimped portion,
wherein the resin-coated portion is provided on the crimped portion while an entire periphery of the crimped portion is coated with the resin-coated portion, and
wherein the resin-coated portion comprises a material that mainly comprises a thermoplastic polyamide resin, and has a tensile lap-shear strength of lapped aluminums equal to or more than 6 N/mm² that is measured in accordance with the JIS K6850, an elongation equal to or more than 100% that is measured in accordance with the ASTM D-1708, and a water absorption equal to or less than 1.0% that is measured in accordance with the JIS K7209.

15. The crimped terminal wire according to claim 14, wherein the thermoplastic polyamide resin comprises
at least one of a dimer acid and a dicarboxylic acid, and a diamine.

16. The crimped terminal wire according to claim 14,
wherein a portion of the resin-coated portion between a top end of the aluminum conductor wire and a top end of the resin-coated portion has a length equal to or more than 0.3 mm.

17. The crimped terminal wire according to claim 15,
wherein a portion of the resin-coated portion between a top end of the aluminum conductor wire and a top end of the resin-coated portion has a length equal to or more than 0.3 mm.

18. The crimped terminal wire according to claim 14,
wherein a portion of the resin-coated portion between a top end of the aluminum conductor wire and a top end of the resin-coated portion has a length equal to or more than 1.0 mm.

19. The crimped terminal wire according to claim 14,
wherein a portion of the resin-coated portion, with which the aluminum conductor wire is coated, has a thickness equal to or more than 0.01 mm.

20. The crimped terminal wire according to claim 17,
wherein a portion of the resin-coated portion, with which the aluminum conductor wire is coated, has a thickness equal to or more than 0.01 mm.

21. The crimped terminal wire according to claim 14,
wherein a portion of the resin-coated portion, with which the aluminum conductor wire is coated, has a thickness equal to or more than 0.1 mm.

22. The crimped terminal wire according to claim 14,
wherein a portion of the resin-coated portion, with which a cutting face of the connecting terminal is coated, has a thickness equal to or more than 0.01 mm.

23. The crimped terminal wire according to claim 20,
wherein a portion of the resin-coated portion, with which a cutting face of the connecting terminal is coated, has a thickness equal to or more than 0.01 mm.

24. The crimped terminal wire according to claim 14,
wherein a portion of the resin-coated portion, with which a cutting face of the connecting terminal is coated, has a thickness equal to or more than 0.1 mm.

25. The crimped terminal wire according to claim 14,
wherein the resin-coated portion comprises a tapered portion at its posterior end portion that has a shape tapering off to the side of the aluminum electric wire.

26. The crimped terminal wire according to claim 23,
wherein the resin-coated portion comprises a tapered portion at its posterior end portion that has a shape tapering off to the side of the aluminum electric wire.

27. The crimped terminal wire according to claim 25,
wherein the tapered portion of the resin-coated portion has a rising angle equal to or less than 45 degrees.

28. The crimped terminal wire according to claim 26,
wherein the tapered portion of the resin-coated portion has a rising angle equal to or less than 45 degrees.

29. The crimped terminal wire according to claim 25,
wherein the tapered portion of the resin-coated portion has a rising angle equal to or less than 30 degrees.

30. The crimped terminal wire according to claim 25,
wherein the tapered portion of the resin-coated portion has a length equal to or more than 1 mm.

31. The crimped terminal wire according to claim 28,
wherein the tapered portion of the resin-coated portion has a length equal to or more than 1 mm.

32. The crimped terminal wire according to claim 25,
wherein the tapered portion of the resin-coated portion has a length equal to or more than 2 mm.
